(19) United States
(12) Patent Application Publication
(10) Pub. No.: US 2004/0237113 A1
(43) Pub. Date: Nov. 25, 2004

(54) Plug-and-play video transmitting device

(75) Inventor: Scott Tseng, Taipei Hsien (TW)

Correspondence Address: TROXELL LAW OFFICE PLLC, SUITE 1404, 5205 LEESBURG PIKE, FALLS CHURCH, VA, 22041, US

(73) Assignee: Taicom Data Systems Co., Ltd.

(21) Appl. No.: 10/440,196

(22) Filed: May 19, 2003

(51) Int. Cl. H04N 7/18; H04N 7/173

(52) U.S. Cl. 725/93; 725/146; 725/116

(57) ABSTRACT

A plug-and-play video transmitting device comprises a converting main machine and a receiver. Wherein the converting main machine includes a first station-selecting control unit, a first control unit, a compressing unit and a first signal receiving and emitting unit; the receiver includes a second signal receiving and emitting unit, a second control unit and a decompressing unit. With these elements, a power line in a socket of a district power supply system carries the television signals and transmits them after they are compressed by the converting main machine; so that a normal television set can synchronically obtain power from a socket of a district power supply system directly through the receiver and decompress the compressed signals. In this way, the effect of convenient assembling and the effect of plug-and-play without arrangement of lines can be obtained.

### BACKGROUND OF THE INVENTION

1. Field of the Invention

The present invention is related to a plug-and-play video transmitting device, and especially to a plug-and-play video transmitting device rendering video signals to get the effect of plug-and-play via carrying of a power line in a district power supply system through receiving and emitting of a converting main machine and a receiver without arrangement of lines; the present invention suits equipments for playing video signals.

2. Description of the Prior Art

Together with progressing and prosperousness of technology and science, the level of human life has been relatively elevated; it is very common that every family has more than one television set. Progressing of technology and science has increased the consumptive ability of every family; however, installation and assembling of the electric lines for television sets still need to be externally connected electric lines for signal transmission.

Transmission of antenna signals from a television set nowadays is done by pulling a television video line into a room to connect to an input end of a television set from an outdoor area. When it is to make other television sets in other rooms also receive the signals, a line separating unit must be added to change the outdoor line for a plurality of lines; these lines then are respectively connected to the individual television sets. This not only may create the trouble of working in arranging lines to increase additional cost, but also may affect the esthetic appearance of indoor decorations; and thus is inconvenient.

In view of the above stated, the present invention is provided to get rid of the defects resided in a conventional video transmitting device.

### SUMMARY OF THE INVENTION

The primary object of the present invention is to provide a plug-and-play video transmitting device rendering video signals to get the effect of plug-and-play via carrying of a power line in a district power supply system through receiving and emitting of a converting main machine and a receiver without arrangement of lines.

To achieve the above stated object, the plug-and-play video transmitting device of the present invention comprises a converting main machine and a receiver.

Wherein the converting main machine includes a station-selecting control unit, a control unit, a compressing unit and a signal receiving and emitting unit; the receiver includes a signal receiving and emitting unit, a control unit and a decompressing unit. With these elements, a power line in a socket of a district power supply system carries the television signals and transmits them to the receiver after a line is pulled in from an outdoor area and the television signals are compressed by the converting main machine; the signals are emitted to a video signal equipment after the receiver decompresses the compressed signals; so that a normal television set can obtain synchronically power and video signals from a socket of a district power supply system directly through the receiver. In this way, the effect of plug-and-play without arrangement of lines can be obtained.

The present invention will be apparent after reading the detailed description of the preferred embodiment thereof in reference to the accompanying drawings.

### BRIEF DESCRIPTION OF THE DRAWINGS

FIG. 1 is a schematic view showing the state in use of a converting main machine and a receiver of the present invention in two-way signal transmitting;

FIG. 2 is a schematic view showing the state in use of a converting main machine and a receiver of the present invention in one-way signal transmitting;

FIG. 3 is a schematic view showing the state in use of the present invention for multiple television sets;

FIG. 4 is a schematic plan view showing the state in use of the present invention for a family.

### DETAILED DESCRIPTION OF THE PREFERRED EMBODIMENT

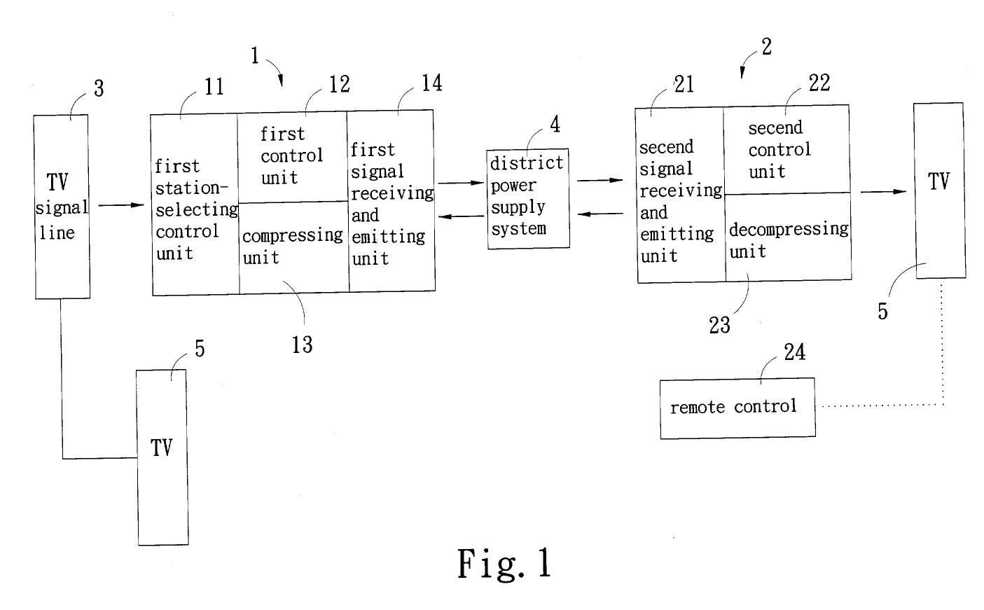

Referring firstly to FIGS. 1-3 showing an embodiment of a plug-and-play video transmitting device of the present invention, the embodiment comprises a converting main machine 1 and a receiver 2.

The converting main machine 1 includes a first station-selecting control unit 11, a first control unit 12, a compressing unit 13 and a first signal receiving and emitting unit 14.

Wherein the first station-selecting control unit 11 is composed of a plurality of channel registers 111 with channel signals therein for storing the selected channel signals. The channel registers 111 are used to separately store signals of a television channel. One end of the first station-selecting control unit 11 is connected with the first control unit 12 and the compressing unit 13; while the other end of it is provided with an input terminal to connect externally with a TV signal line 3;

the first control unit 12 is connected with the first station-selecting control unit 11, the compressing unit 13 and the first signal receiving and emitting unit 14 to control the converting main machine 1 in executing station selecting, compressing and signal receiving and emitting;

the compressing unit 13 is connected on one end thereof with the first station-selecting control unit 11 and the first control unit 12 for compressing the channel signals selected, while the other end of it is connected to the first signal receiving and emitting unit 14; the signal compressing can be done by the compressing unit 13 at least adopting the specification of MPEG4;

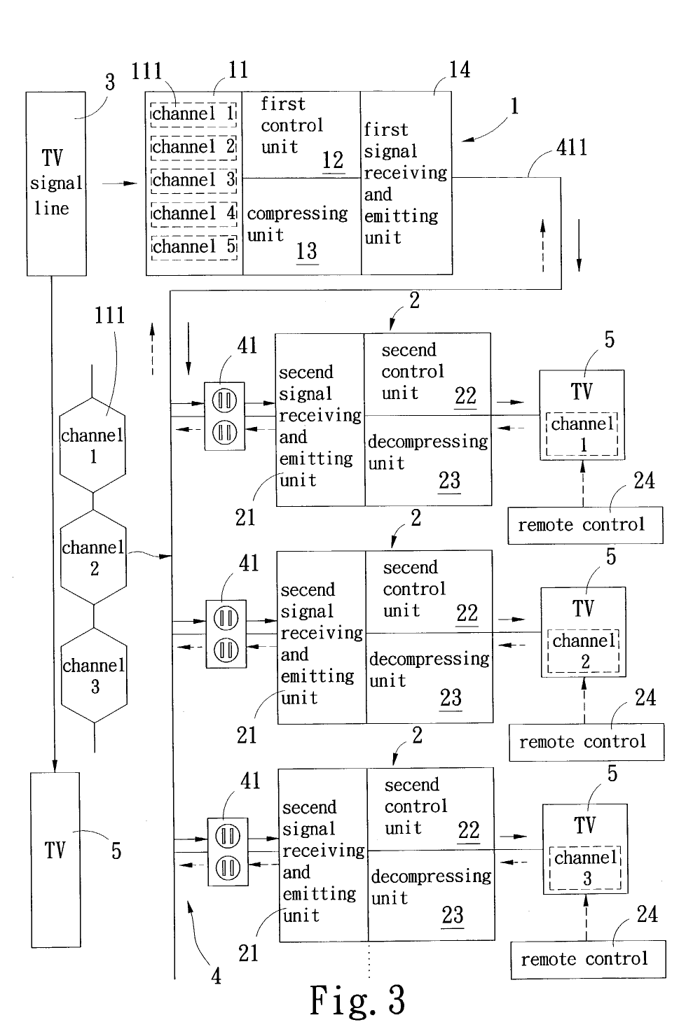

the first signal receiving and emitting unit 14 is connected on one end thereof with the first control unit 12 and the compressing unit 13, while the other end of it is provided with an output terminal to output the signals dealt with by the converting main machine 1 to a power line 411 of a district power supply system 4 (as shown in FIG. 3).

The receiver 2 includes a second signal receiving and emitting unit 21, a second control unit 22 and a decompressing unit 23.

Wherein the second signal receiving and emitting unit 21 is connected on one end thereof with the second control unit 22 and the decompressing unit 23, while is provided on the other end thereof with a receiving terminal connected externally to a socket 41 of the district power supply system 4 for receiving the signals from the power line 411;

the second control unit 22 is connected with the second signal receiving and emitting unit 21 and the decompressing unit 23 to control the receiver 2 in executing decompressing and signal receiving and emitting;

the decompressing unit 23 is connected on one end thereof with the second control unit 22 and the second signal receiving and emitting unit 21, while the other end of it is provided with a signal emitting terminal for decompressing the signals received and converting them into video signals visible on a TV 5.

The receiver 2 can be provided as an individual unit, and can be made as a circuit board to be mounted in the TV 5, or be made as a specified chip element for selection of and mounting on a related electric appliance.

Thereby, a common TV can obtain synchronically power and video signals from the socket 41 of the district power supply system 4 directly through the receiver 2.

When in practicing as shown in FIGS. 1, 3 and 4, the power line 411 only carries the partial channel signals selected by the receiver 2 for the sake of smooth transmission of the power line 411, the receiver 2 and the converting main machine 1 are in the operation of two-way signal transmitting, so that when in executing station selecting, the receiver 2 transmits signals through the converting main machine 1 for switching.

Taking a family as an example, the TV signal line 3 pulled in from an outdoor area is connected to the input terminal of the converting main machine 1 of the present invention, the converting main machine 1 is installed in a parlor e.g., the output terminal of the converting main machine 1 is connected via a line to an indoor socket 41; the other rooms are installed with receivers 2 corresponding with the TV 5. The receiving terminals of the receivers 2 are connected via lines to a plurality of indoor sockets 41; while the emitting terminals of the receivers 2 are connected to the signal-receiving terminals of the TV's 5 in the other rooms. In this mode, the television channel signals received by the converting main machine 1 are partially compressed by the converting main machine 1, and then the compressed signals are sent to the power line 411 of the district power supply system 4 in the mode of carrying in an envelopment; while the other receivers 2 in other rooms receive the decompressed signals through the power line 411. The receivers 2 decompress the compressed signals, and the decompressed channel signals are sent to the TV's 5 in the other rooms through the emitting terminals, thus the TV's 5 can play the images in corresponding with the selected channels of the TV's 5.

When it is desired to switch for seeing programs of other channels, a station-selecting switch (such as a remote control) 24 can be used to select, the receiving terminal of the remote control 24 now can transmit the selected channels to the converting main machine 1 in the parlor through the power line 411; and the converting main machine 1 compresses the television signals selected and send them to the receivers 2 in the other rooms through the power line 411 for decompression to render the TV's 5 to see the programs of the selected channels.

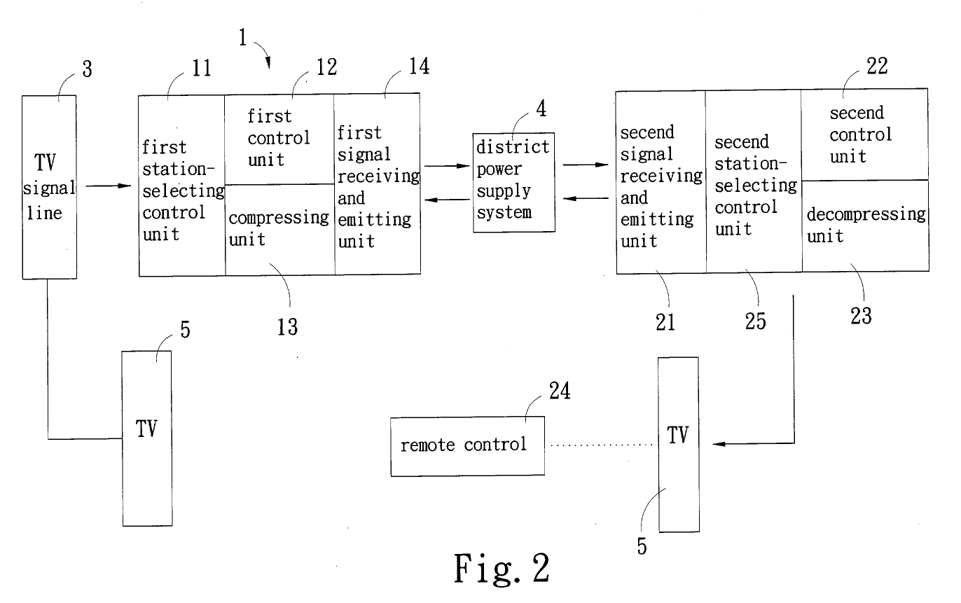

Moreover, referring to FIG. 2, in practicing the present invention, the power line 411 can carry all the channel signals on the TV signal line 3 and store them; the receiver 2 and the converting main machine 1 do one-way signal transmitting between themselves. The receiver 2 can be added with a second station-selecting control unit 25 which is connected on one end thereof with a second signal receiving and emitting unit 21 and is connected on the other end thereof with a second control unit 22 and a compressing unit 23 for storing the selected channel signals. When a user changes for a channel, he can directly select to switch per se through the receiver 2, and needs not make choices one by one through the converting main machine 1 for switching.

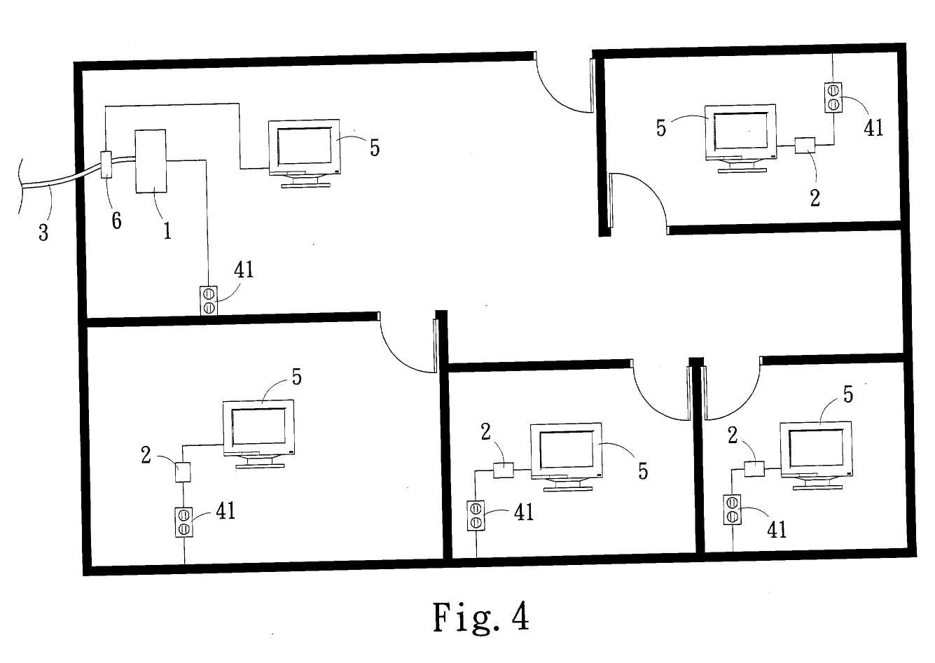

Thereby as shown in FIG. 4, the TV signal line 3 pulled into the parlor from an outdoor area needs only a separating unit 6 for changing one line to two lines is required to transmit signals respectively to the converting main machine 1 and the TV 5 in the parlor. When the output terminal of the converting main machine 1 is inserted into the indoor socket 41, the television channel signals are all carried by the power line 411 in the socket 41, then the TV's 5 in other rooms can directly obtain the power and all the video signals at any socket 41 in these rooms through one of the receivers 2 to make selection for switching.

By virtue that the present invention only needs to use the provision of the existing indoor power line 411 to render the television video signals to be sent through the power line 411 totally without additional arrangement of lines. This will not damage the entire esthetic appearance of the indoor decoration and thus is different from the conventional way that has to have the TV signal line 3 pulled into all the rooms from an area far away, thereby trouble of distribution work can be avoided, working for the present invention can save time and man power consumption, and the practicability of plug-and-play can be obtained.

In conclusion, the present invention can get its expected object to provide a plug-and-play video transmitting device rendering video signals to get the effect of plug-and-play via carrying of a power line in a district power supply system (such as a city electric socket) through receiving and emitting of a converting main machine and a receiver without arrangement of lines. The device has a high industrial value; having thus described my invention, what I claim as new and desire to be secured by Letters Patent of the United States are:

1. A plug-and-play video transmitting device, said device comprises:
a) a converting main machine including a first station-selecting control unit, a first control unit, a compressing unit and a first signal receiving and emitting unit; wherein:
said first station-selecting control unit is composed of a plurality of channel registers with channel signals therein for storing selected channel signals; one end of said first station-selecting control unit is connected with said first control unit and said compressing unit, while the other end of it is provided with an input terminal to connect externally with a TV signal line;
said first control unit is connected with said first station-selecting control unit, said compressing unit and said first signal receiving and emitting unit to control said converting main machine in executing station selecting, compressing and signal receiving and emitting;
said compressing unit is connected on one end thereof with said first station-selecting control unit and said first control unit for compressing said channel signals selected, while the other end of it is connected to said first signal receiving and emitting unit;
said first signal receiving and emitting unit is connected on one end thereof with said first control unit and said compressing unit, while the other end of it is provided with an output terminal to output the signals dealt with by said converting main machine to a power line of a district power supply system;
b) a receiver including a second signal receiving and emitting unit, a second control unit and a decompressing unit, wherein:
said second signal receiving and emitting unit is connected on one end thereof with said second control unit and said decompressing unit of said receiver, while is provided on the other end thereof with a receiving terminal connected externally to a socket of said district power supply system for receiving the signals from said power line;
said second control unit is connected with said second signal receiving and emitting unit and said decompressing unit of said receiver to control said receiver in executing decompressing and signal receiving and emitting;
said decompressing unit is connected on one end thereof with said second control unit and said second signal receiving and emitting unit of said receiver, while the other end of it is provided with a signal emitting terminal for decompressing the signals received and converting them into video signals visible on a TV;
thereby, a common TV is adapted to obtaining synchronically power and video signals from said socket of said district power supply system directly through said receiver.

2. The plug-and-play video transmitting device as in claim 1, wherein said power line of said district power supply system only carries partial television channel signals, said receiver and said converting main machine are in the operation of two-way signal transmitting, so that when in executing station selecting, said receiver transmits signals through said converting main machine for switching.

3. The plug-and-play video transmitting device as in claim 1, wherein said channel registers are used to separately store signals of a television channel.

4. The plug-and-play video transmitting device as in claim 1, wherein said receiver is added with a second station-selecting control unit which is connected on one end thereof with said second signal receiving and emitting unit of said receiver and is connected on the other end thereof with said second control unit and said compressing unit of said receiver for storing selected channel signals.

5. The plug-and-play video transmitting device as in claim 4, wherein said power line carries all said channel signals on said TV signal line and store them; said receiver and said converting main machine do one-way signal transmitting between themselves, said receiver itself is adapted to selecting station and switching.

6. The plug-and-play video transmitting device as in claim 1, wherein said receiver includes a remote control.

7. The plug-and-play video transmitting device as in claim 4, wherein said receiver includes a remote control.

8. The plug-and-play video transmitting device as in claim 1, wherein said receiver is built in a television set.

9. The plug-and-play video transmitting device as in claim 4, wherein said receiver is built in a television set.

10. The plug-and-play video transmitting device as in claim 1, wherein said receiver is made as a specified chip element.

11. The plug-and-play video transmitting device as in claim 4, wherein said receiver is made as a specified chip element.

12. The plug-and-play video transmitting device as in claim 1, wherein said compressing unit is of the specification MPEG4.

13. The plug-and-play video transmitting device as in claim 4, wherein said compressing unit is of the specification MPEG4.
